(19) United States
(12) Patent Application Publication
(10) Pub. No.: US 2025/0192196 A1
(43) Pub. Date: Jun. 12, 2025

(54) FUEL CELL SYSTEM FOR GENERATING ELECTRIC ENERGY

(71) Applicant: AVL List GmbH, Graz (AT)

(72) Inventors: Raphael NEUBAUER, Graz (AT); Bhargav PANDYA, Graz (AT); Markus GOLL, Graz (AT)

(73) Assignee: AVL List GmbH, Graz (AT)

(21) Appl. No.: 18/875,191

(22) PCT Filed: Aug. 8, 2023
(86) PCT No.: PCT/AT2023/060264

§ 371 Date: Dec. 16, 2024

(30) Foreign Application Priority Data
Aug. 9, 2022 (AT) A 50611/2022

(51) Int. Cl. H01M 8/04014; H01M 8/04119; H01M 8/0662

(52) U.S. Cl. CPC H01M 8/04014; H01M 8/04164; H01M 8/0662

(57) ABSTRACT

The present invention relates to a fuel cell system (100) for generating electrical energy, comprising a fuel cell stack (110) with an anode section (120) and a cathode section (130), the anode section (120) comprising an anode supply section (122) for supplying anode feed gas (AZG) and an anode discharge section (124) for discharging anode exhaust gas (AAG), the cathode section (130) comprising a cathode supply section (132) for supplying cathode feed gas (KZG) and a cathode discharge section (134) for discharging cathode exhaust gas (KAG), wherein the anode discharge section (124) has a divider section (125) for dividing the anode exhaust gas (AAG) into an anode recirculation section (140) for recirculation as anode recirculation gas (ARG) and an anode outlet section (150) for discharge into the environment as anode outlet gas (AUG), wherein a condenser device (126) is arranged in the anode discharge section (124) or in the anode recirculation section (140) in heat-transmitting contact with the cathode supply section (132) to cool the anode exhaust gas (AAG) or the anode recirculation gas (ARG) by heating up the cathode feed gas (KZG), wherein a water outlet (128) is arranged downstream of the condenser device (126) to discharge the condensation water (KW) condensed in the condenser device (126), wherein a mixing section (123) is arranged downstream of the water outlet (128) for mixing the anode recirculation gas (ARG) with fuel gas (BRG) and for supplying this, as anode feed gas (AZG), into the anode supply section (122).

The present invention relates to a fuel cell system for generating electrical energy and a method for recirculating anode exhaust gas in such a fuel cell system.

It is known that fuel cell systems are used for the generation of electrical energy. For this purpose, these fuel cell systems are usually equipped with fuel cell stacks in which numerous individual fuel cells, each with an anode section and a cathode section, are stacked. To generate electrical energy, fuel gas and usually ambient air are fed into the fuel cell stack so that a chemical reaction of these gases can take place there, generating electrical energy.

In known fuel cell systems, either hydrogen or natural gas is usually used as fuel gas. In addition, it is known for part of the fuel gas which is not reacted during the reaction in the fuel cell stack to be fed back into the fuel cell stack as recirculation gas for recirculation in order to increase the efficiency in the use of the fuel gas.

A disadvantage of the known solutions is that recirculation can reduce efficiency in operation, in particular when hydrogen is used as fuel gas. If hydrogen is fed into a fuel cell stack, this hydrogen is converted in the anode section to a mixture of water and a remaining residue of hydrogen in the anode exhaust gas. During the recirculation of this gas mixture, it can happen that the water contained therein significantly decreases the Nernst voltage. The decrease in the Nernst voltage for the fuel cell stack leads to a reduction in efficiency, which usually offsets the increase in efficiency due to recirculation. In other words, when operating a fuel cell system with hydrogen, recirculation does not lead to the desired increase in efficiency, or only does so to a reduced extent.

Although it is already known in principle that, during recirculation, cooling of the anode exhaust gas can be used to condense part of the water contained therein and to separate this condensation water, these construction designs are however very complex and costly. In particular, they are based on the fact that an external cooling circuit must be used which is able to pass coolant to the recirculation line with an external heat sink in order to cause condensation of the vaporous water in the anode exhaust gas. The addition of an additional cooling circuit and the corresponding peripherals leads to an undesirable increase in the complexity and costs of a fuel cell system.

It is the object of the present invention to remedy, at least in part, the disadvantages described above. In particular, it is the object of the present invention to discharge condensation water in a fuel cell system in a cost-effective and simple manner, even when operated with hydrogen.

The above object is achieved by a fuel cell system with the features of claim 1 and a method with the features of claim 12. Further features and details of the invention are disclosed in the dependent claims, the description and the drawings. Naturally, features and details described in connection with the fuel cell system according to the invention also apply in connection with the method of the invention and vice versa, so that with regard to disclosure mutual reference is or can always be made to the individual aspects of the invention.

According to the invention, a fuel cell system for generating electrical energy is proposed. This has a fuel cell stack with an anode section and a cathode section. The anode section is equipped with an anode supply section for supplying anode feed gas and an anode discharge section for discharging anode exhaust gas. In the same way, the cathode section is equipped with a cathode supply section for supplying cathode feed gas and with a cathode discharge section for discharging cathode exhaust gas. A divider section is provided in the anode discharge section which allows the anode exhaust gas to be divided into an anode recirculation section for recirculation as anode recirculation gas and an anode outlet section for discharge into the environment as anode outlet gas. A fuel cell system according to the invention is characterised in that a condenser device is arranged in the anode discharge section or in the anode recirculation section in heat-transferring contact with the cathode supply section. This is used to cool the anode exhaust gas or the anode recirculation gas by heating up the cathode feed gas. Downstream of this condenser device, a water outlet is arranged downstream of the condenser device to discharge the condensation water condensed in the condenser device. A mixing section is arranged downstream of the water outlet for mixing the anode recirculation gas with the fuel gas and for supplying this, as anode feed gas, into the anode supply section.

The core idea of the invention is based on ensuring a recirculation of anode exhaust gas. This recirculation takes place in a divided manner, so that, with the help of the divider section, part of the anode exhaust gas is recirculated as anode recirculation gas. The remaining anode exhaust gas is discharged into the environment as anode outlet gas. As will be explained later, this anode outlet gas can also be subjected to a post-treatment. In particular, the anode outlet gas can be combined with the cathode exhaust gas.

The recirculation of the anode recirculation gas takes place in a dried manner, namely by passing it through a condenser device. In this condenser device, the temperature of the anode exhaust gas or the anode recirculation gas is brought below the boiling temperature of water, i.e. below about 100° C., depending on the pressure situation and depending on a partial pressure which depends on the composition of the gas. This leads to the water vapour contained in the anode recirculation gas condensing out in the form of liquid condensation water. It should be noted here that, depending on the positioning of the divider section, the condenser device can be located before this divider section, in the anode discharge section, but also after this divider section, in the anode recirculation section. In both cases, the advantages according to the invention are achievable.

A separator is provided downstream of the condenser device as a water outlet in which the condensed components and thus the condensation water are separated from the gaseous components of the anode recirculation gas. This allows the liquid condensation water to be removed from the system and for example discharged into the environment. The remaining anode recirculation gas can also be described as dried anode recirculation gas and can accordingly be fed into a mixing section in this dried situation. In this mixing section, which can for example be designed as an ejector device, a mixing chamber or in a similar way, the anode recirculation gas is mixed with a fuel gas supplied from a fuel gas source. Depending on how much anode recirculation gas is available, the necessary residual amount of fuel gas can be added accordingly. The mixed gas consisting of fuel gas and anode recirculation gas is then fed back into the anode section of the fuel cell stack as anode feed gas.

The core idea of the invention is based, among other things, on the fact that no external cooling source nor any separate external refrigeration circuit is required for the condensation of the condensation water in the anode recirculation gas or in the anode exhaust gas. Rather, according to the invention the condenser device is designed to be in heat-transferring contact with the cathode supply section. Since such a fuel cell system is operated with air as cathode feed gas for the cathode section, air is, accordingly, sucked in from the environment. This suction intake can for example take place using a fan device. The sucked-in air has a corresponding ambient temperature, which can range from −20° C. to 50° C. or even more, depending on the temperature situation. It is crucial that even in very hot operational situations, for example in desert areas, the ambient air does not exceed the boiling temperature of water, usually 100° C. In other words, even at a hot ambient temperature, the supplied ambient air is sufficient as a heat sink to provide a cooling capacity for the anode exhaust gas or the anode recirculation gas as the coldest available temperature, which allows cooling to below the condensation temperature of water. As can be seen from the above explanation, simply by supplying air from the environment as cathode feed gas, a cooling source is provided, so to speak as a secondary functionality, which can also be described as a heat sink. This heat sink serves to extract so much heat energy from the recirculated anode exhaust gas as anode recirculation gas in the condenser device that the temperature of the anode exhaust gas or the anode recirculation gas drops below the boiling temperature of water. According to the invention, this condensation process takes place without the influence of external cooling sources, in particular without an external cooling circuit of the fuel cell system.

It should also be noted that, in a complex fuel cell system, cooling circuits may of course be provided at other positions in order to be able to carry out desired temperature control processes. In particular, very high temperatures are to be expected in fuel cell systems that are designed as SOFC systems, so that parts of the fuel cell stack can for example be designed with an external cooling device. According to the invention, however, any such existing external cooling source is also not used for the condensing function of the anode recirculation gas and the anode exhaust gas.

According to the invention, the integration of the condensation function into the cathode supply section achieves the desired condensation of condensation water in the anode recirculation gas or in the anode exhaust gas. In this way, dried anode recirculation gas is mixed with the fuel gas and, accordingly, the desired increase in efficiency is achieved through recirculation without having to accept a reduced Nernst voltage, as in the case of undried anode recirculation gas. Compared to the known solutions, this drying step and the associated increase in efficiency in the operation of the fuel cell system is achieved without additional complex components, in particular exclusively by a condenser device designed as a gas-gas heat exchanger.

As a result, in addition to the increase in efficiency, in particular a smaller ejector can actually be used, since correspondingly lower volume flows have to be added to the fuel gas due to the separation of the unwanted condensation water.

It can be advantageous if, in a fuel cell system according to the invention, the anode discharge section has an anode discharge heat exchanger in heat-transferring contact with the anode supply section to transfer heat from the anode exhaust gas to the anode feed gas. This makes possible a further increase in efficiency from the point of view of temperature. In connection with the other possible different heat exchangers explained later, a heat exchanger system is created together with the condenser device which can also be referred to as a temperature control system, which allows the greatest possible proportion of residual heat in the anode exhaust gas as well as in the cathode exhaust gas to be recycled and used for other functions, for example condensation, but also the supply and conditioning of anode feed gas and cathode feed gas. In this embodiment, there is thus a possibility of cooling the hot anode exhaust gas and using this energy to heat up the anode feed gas as it is fed to the anode section. As a side effect, this leads to anode exhaust gas which has already been pre-cooled arriving at the condenser device, so that lower input temperatures can accordingly be assumed at the condenser device, and the necessary condenser capacity is thus less. In other words, this makes it possible to equip the condenser device with the desired condensation function even with lower air flows, but also with smaller designs and construction volumes.

It can also bring advantages if, in a fuel cell system according to the invention, the mixing section is designed as an ejector device, with a fuel supply of fuel gas at a primary connection of the ejector device and the anode recirculation section at the secondary connection of the ejector device. The use of an ejector device as an alternative to classic blower devices for the mixing section brings many advantages.

On the one hand, rotating components and corresponding parts subject to wear are dispensed with. On the other hand, mixing and conveying are preferably combined in a common component, so that, particularly if a fuel gas source with high delivery pressure is available, a separate conveying device in the anode supply section is no longer necessary. Rather, it is sufficient to apply the corresponding fuel gas to the primary connection of the ejector device with the desired input pressure, so that the corresponding suction effect resulting at the secondary connection of the ejector device sucks in the dried anode recirculation gas for mixing. The overall efficiency is thus further increased for a fuel cell system according to the invention and, in particular, the low-wear properties are improved.

It is also advantageous if, in a fuel cell system according to the invention, the cathode discharge section has a catalyst device which is connected in a fluid-communicating manner to the anode outlet section and is provided for a catalytic post-treatment of the anode outlet gas and the cathode exhaust gas. As has already been explained, part of the anode exhaust gas is separated from the anode recirculation gas in the divider section and is to be released into the environment. As has also been explained, the anode exhaust gas has a residual component of fuel gas, for example hydrogen or ammonia. To ensure that this hydrogen is not released into the environment in pure form, a catalytic post-treatment can take place in such a catalyst device. In order to provide a sufficiently large oxygen content for this catalytic post-treatment, a mixing with the cathode exhaust gas is preferably provided in or before this catalyst device. The aim of this catalytic post-treatment is in particular to reduce the fuel gas content in the anode outlet gas to below a minimum or even to consume it completely. This leads to an increase in safety and, especially if heat is generated in this way, can lead to a further increase in efficiency. This is in particular the case if the heat generated on this catalyst device, which is for example designed as an oxidative catalyst, is fed back into the fuel cell system at another position via heat exchanger devices. If the fuel cell system is operated with ammonia, it can be advantageous if, in addition, a post-treatment unit which also converts the last remnants of ammonia is provided.

Another advantage is achievable if, in a fuel cell system according to the invention, the cathode supply section has a cathode supply heat exchanger in heat-transferring contact with the cathode discharge section to transfer heat from the cathode exhaust gas to the cathode feed gas. Similarly to the preheating of the anode feed gas, it further increases the efficiency in the operation of the fuel cell system if the cathode feed gas is also preconditioned so that it enters the cathode section at the highest possible temperature, and thus in particular close to the operating temperature of the fuel cell stack. Since the cathode exhaust gas has been brought to a correspondingly high outlet temperature as a result of the chemical reaction within the fuel cell stack, this high temperature can be used here to be partially transferred to the cathode feed gas. This corresponds to a preconditioning in the form of preheating from the cathode exhaust gas to the cathode feed gas. This recovery of the heat contained in the cathode exhaust gas increases efficiency even further and avoids heat loss through the cathode exhaust gas. Preferably, this cathode supply heat exchanger is located directly upstream before the cathode section and thus in the cathode discharge section upstream of a catalyst device and in the cathode supply section after the condenser device.

Further advantages can be achieved if, in a fuel cell system according to the invention, the divider section is arranged at one of the following positions:
upstream of the condenser device,
downstream of the condenser device and downstream of the water outlet,
downstream of the condenser device and upstream of the water outlet.

The above list consists of three different positions which preferably cannot be occupied at the same time. If the division takes place upstream of the condenser device, the subsequent condensation process as well as the discharge of condensation water must only be carried out for the anode recirculation gas that has actually been recycled. However, it can also bring advantages to route the complete anode exhaust gas via the condenser device and even via the water outlet, so that, as a result of the later arrangement of the divider section, the complete anode exhaust gas is not only cooled but also freed from water. In particular if a higher preconditioning capacity is required for the air than for the cathode feed gas, it can be advantageous also to use the residual heat of the entire volume flow of anode exhaust gas for this preheating in that not only the separated anode recirculation gas but the entire anode exhaust gas is routed via the condenser device. Since in such a case correspondingly larger quantities of condensation water are produced, it is also advantageous if this divider section is located not only between the condenser device and the water outlet but preferably downstream of the water outlet. This allows a maximum heat effect to be achieved for the cathode feed gas, and at the same time the larger amount of condensation water produced can be separated from the anode recirculation gas before it is fed into the divider section and later the mixing section.

It also brings advantages if, in a fuel cell system according to the invention, a cathode discharge heat exchanger is arranged in the anode supply section, preferably downstream of an anode supply heat exchanger, to transfer heat from the cathode exhaust gas to the anode feed gas. This allows heat also contained in the cathode exhaust gas to be transferred to the anode feed gas, in addition or alternatively. In addition, in combination with an anode supply heat exchanger, this also makes it possible to increase the corresponding preheating functionality even further, or in other words to bring the anode feed gas to an even higher temperature. As shown, the system of heat exchangers in a fuel cell system according to the invention can be provided at a variety of positions via heat exchanger functions. Of course, individual heat exchangers of this heat exchanger system can be controlled via valves, so that different parts of this heat exchanger system can be activated or deactivated, in particular flexibly, depending on the operating situation. This makes it possible to react specifically and flexibly to different operating situations and always achieve maximum temperature efficiency.

It can also be advantageous if, in a fuel cell system according to the invention, a cathode supply heat exchanger is arranged in the cathode supply section to transfer heat from the cathode exhaust gas to the cathode feed gas. This is also conceivable as an alternative, but also in addition to the other heat exchangers mentioned, whereby it should be pointed out that valves can preferably activate and deactivate the different heat exchangers. Here too, it is again possible, through the transfer of heat, to use residual heat from the cathode exhaust gas in order to be able to guarantee preconditioning in the form of pre-heating of the cathode feed gas and thus further increase the operating efficiency of the fuel cell system.

In addition, it can be advantageous if, in a fuel cell system according to the invention, a control valve is arranged in the anode supply section upstream of the mixing section to control the volume flow of fuel gas through the mixing section. This makes it possible to control the quantity and pressure of the fuel gas, in particular from a pressurised fuel gas source, in a controlled manner. Depending on the amount of anode recirculation gas diverted, a correspondingly adapted amount of fuel gas can now be added, so that the desired composition and the desired volume flow of anode feed gas is always actually made available to the anode section. It is therefore preferable that this control valve is a quantitatively controllable control valve in order to be able to react flexibly to a wide variety of operating situations of the fuel cell system.

In addition, it is advantageous if, in a fuel cell system according to the invention, the anode discharge section is designed without an external cooling circuit. As has already been explained, the core idea of the present invention is to provide this condensation function as efficiently as possible and without additional complexity. The design of the anode discharge section without an external cooling circuit embodies precisely this reduced complexity, since the condensation function is essentially guaranteed exclusively by the heat sink which is provided by the supplied ambient air as cathode feed gas.

It is also advantageous if, in a fuel cell system according to the invention, a cathode mixing section, in particular in the form of an ejector device, is arranged in the cathode supply section. A cathode recirculation section is connected to this ejector device in a fluid-communicating manner at the secondary connection to provide a recirculation of part of the cathode exhaust gas as cathode recirculation gas. In combination with the recirculation to the anode section, this can also be referred to as double recirculation. This makes it possible to feed the cathode exhaust gas and the residual oxygen contained therein back into the cathode section as an admixture with the cathode feed gas.

The subject matter of the present invention also includes a method for a recirculation of anode exhaust gas as anode recirculation gas in a fuel cell system according to the invention, comprising the following steps:
diverting at least part of the anode exhaust gas as anode recirculation gas to the anode recirculation section,
cooling the anode recirculation gas to below the boiling temperature of water by transferring heat to the cathode feed gas,
separating the condensed condensation water from the anode recirculation gas,
mixing the dried anode recirculation gas with a fuel gas to form anode feed gas.

When used in a fuel cell system according to the invention, a method according to the invention brings the same advantages as have been explained in detail with reference to a fuel cell system according to the invention.

Further advantages, features and details of the invention are explained in the following description, in which embodiments of the invention are described in detail with reference to the drawings. In each case schematically:

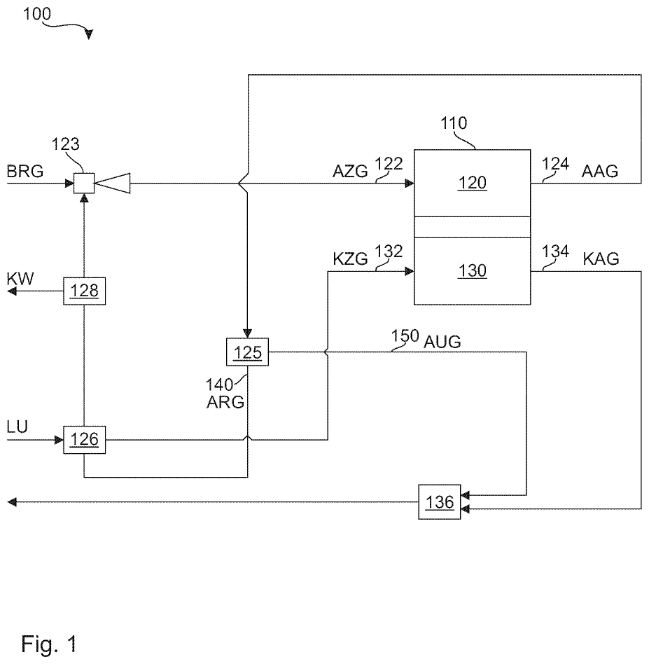

FIG. 1 shows an embodiment of a fuel cell system according to the invention,

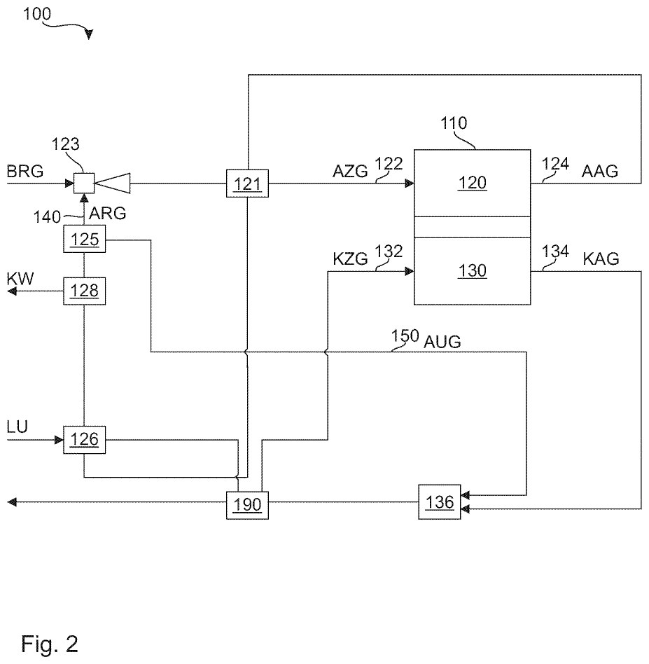

FIG. 2 shows a further embodiment of a fuel cell system according to the invention,

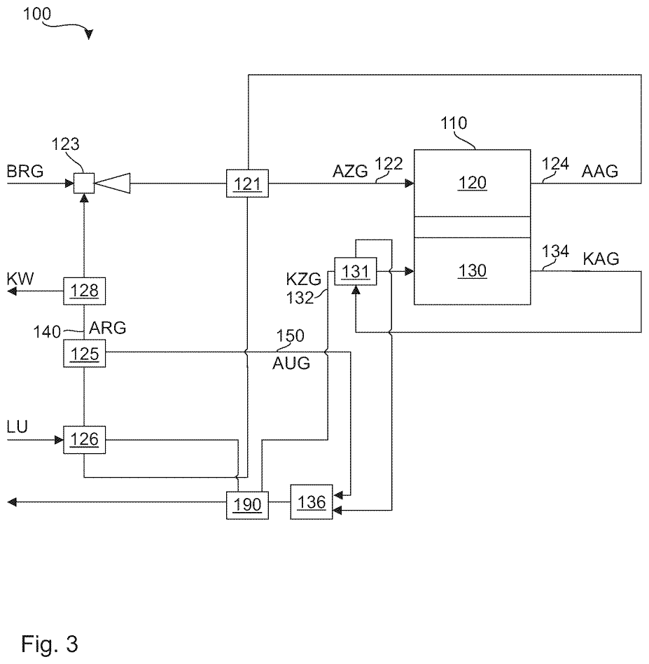

FIG. 3 shows a further embodiment of a fuel cell system according to the invention,

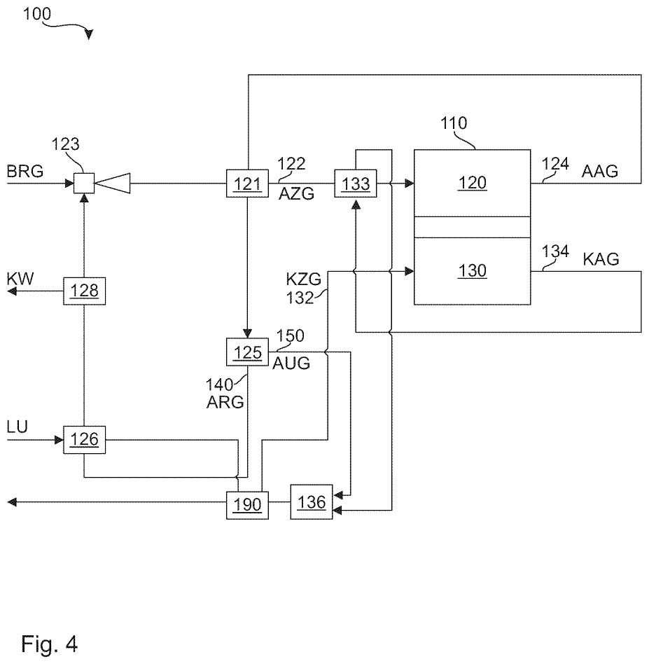

FIG. 4 shows a further embodiment of a fuel cell system according to the invention,

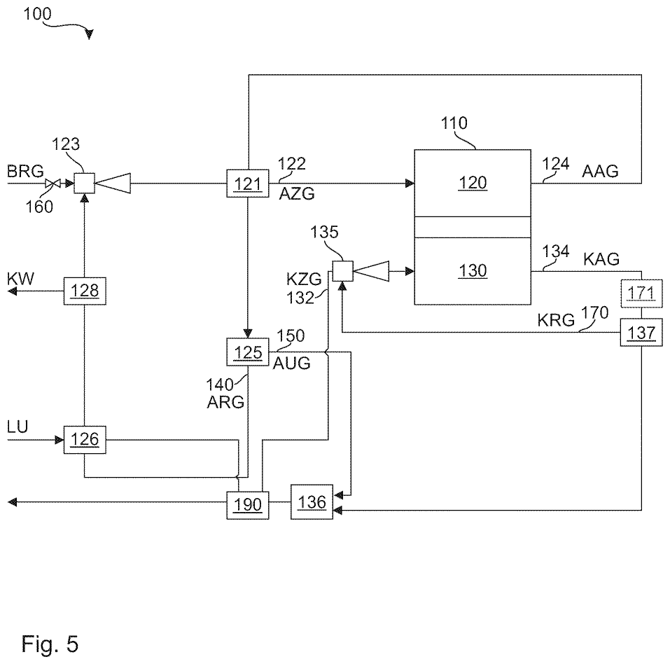

FIG. 5 shows a further embodiment of a fuel cell system according to the invention,

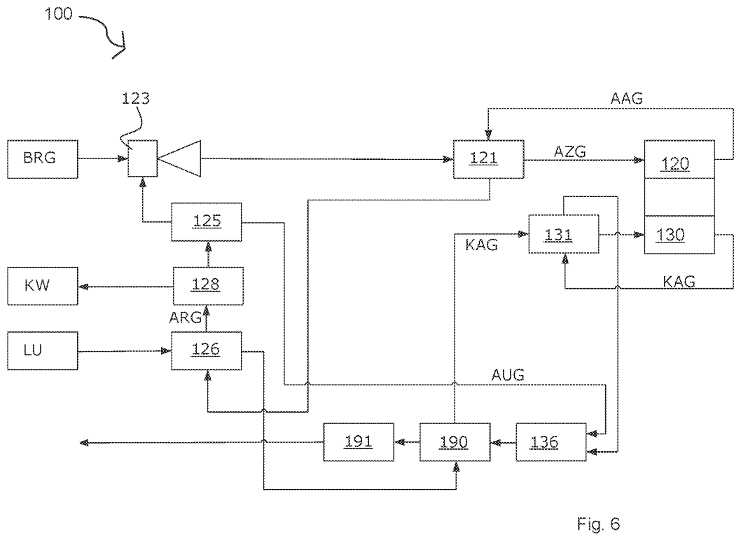

FIG. 6 shows a further embodiment of a fuel cell system according to the invention.

FIG. 1 shows schematically a fuel cell system 100 for generating electrical energy. Shown here schematically is a fuel cell stack 110 which has an anode section 120 and a cathode section 130. Of course, in this fuel cell stack 110 a large number of individual fuel cells are stacked on top of each other which, accordingly, have a large number of individual anode sections 120 and cathode sections 130. For the sake of simplicity, the entire stack is shown here with an anode supply section 122, an anode discharge section 124, a cathode supply section 132 and a cathode discharge section 134.

During operation of the fuel cell system 100, fuel gas BRG is supplied from a fuel source, which is not shown in detail. This fuel gas BRG is mixed here with the anode recirculation gas ARG, which will be explained later, to form anode feed gas AZG, whereby an ejector device is used as mixing section 123. This is used to suck in the anode recirculation gas ARG and also to mix it with the fuel gas BRG.

The anode feed gas AZG is now fed into the anode section 120 in the anode supply section 122 and can be reacted there with cathode feed gas KZG in the form of air LU. In addition to the electrical energy that is to be generated during operation, as the object of the fuel cell system 100, this chemical reaction generates heat, which causes the anode exhaust gas AAG and the cathode exhaust gas KAG to heat up. The hot anode exhaust gas AAG is now fed into a divider section 125, in which it is divided into an anode recirculation gas ARG in an anode recirculation section 140 and an anode outlet gas AUG in an anode outlet section 150. The outlet section can also be flexibly controlled, so that in particular it is possible to adjust the volume proportions between the anode recirculation gas ARG and the anode outlet gas AUG.

As the still-hot anode recirculation gas ARG is passed onwards, it is now fed via a condenser device 126 which has a heat exchanger function with the supplied air LU. The air LU is taken from the environment and is accordingly at ambient temperature, so that it has a temperature below the boiling temperature of water, even in very hot environmental situations. This makes it possible to cool the anode exhaust gas AAG, in this case as anode recirculation gas ARG, below this boiling temperature so that the water components contained therein condense and are present as condensation water KW in the anode recirculation gas ARG which is passed onwards. This mixture of condensation water KW and dried anode recirculation gas ARG is fed via a separator in the form of a water outlet 128 so that the condensation water KW can be separated and discharged into the environment. The remaining dried anode recirculation gas ARG is now fed to the ejector device as mixing section 123, so that the residual amount of fuel remaining in the anode recirculation gas ARG is mixed with new fuel gas BRG and fed back to the anode section 120 as anode feed gas AZG.

The cathode exhaust gas KAG also has a correspondingly high temperature and is post-treated before it is released into the environment. In the simplest version according to FIG. 1, a catalyst device 136 is provided as a post-treatment, in which a mixture of cathode exhaust gas KAG and anode outlet gas AUG undergoes catalytic post-treatment together. The aim of this catalytic post-treatment is in particular to reduce the volume content of residual fuel gas BRG in the anode outlet gas AUG in order to enable the safest possible outlet of this mixed gas consisting of anode outlet gas AUG and cathode exhaust gas KAG into the environment.

FIG. 2 shows a further development of the embodiment of FIG. 1, whereby in this case, by way of example, various additional components are integrated which can be used individually or in combination. One of these additional components is an anode supply heat exchanger 121. This allows the anode exhaust gas AAG to be pre-cooled so that it then requires a lower cooling capacity on the condenser device 126. This pre-cooling takes place through the transfer of heat from the hot anode exhaust gas AAG to the preconditioned anode feed gas AZG, so that at the same time this pre-cooling has a positive effect on the anode feed gas, which can further increase the efficiency of operation of the fuel cell system 100.

Another additional component in FIG. 2 is the air heat exchanger 190, which is located here in the cathode supply section 132, downstream of the condenser device 126. In this way, the cathode feed gas KZG which has already been heated by the condenser device 126 is further heated after the catalyst device 136 by residual heat from the mixed gas present therein and, accordingly, a higher inlet temperature for the cathode feed gas KZG at the cathode section 130 is achieved.

A third distinction from FIG. 1 in FIG. 2 is the position of the divider section 125. Here, this is arranged downstream of the water outlet 128, so that, accordingly, the complete anode exhaust gas AAG undergoes the condensation function as well as the water outlet function. This allows maximum heat recovery from the anode exhaust gas, but conversely requires a correspondingly larger condenser device 126 in order to be able to suck in and convey correspondingly higher amounts of air LU for cooling. Since the condensation water KW is now also completely separated from the entire dried anode exhaust gas AAG, only the dried anode exhaust gas is thus conveyed further in the fuel cell system 100 as anode recirculation gas ARG and as anode outlet gas AUG.

FIG. 3 also shows additional components which can in particular further increase the efficiency of the fuel cell system 100. On the one hand, a cathode supply heat exchanger 131 is also provided here which allows heat recovery from the hot cathode exhaust gas KAG into the cathode feed gas KZG. This means that the cathode feed gas KZG is supplied with heat at three points, namely in the condenser device 126, in the air-heat exchanger 190 and finally, as the last heat transfer, in the cathode supply heat exchanger 131. FIG. 3 also shows a variant in which the divider section 125 is provided downstream of the condenser device 126 but upstream of the water outlet 128. This allows the corresponding advantages of transferring the heat recovered from the anode exhaust gas AAG completely to the air LU in the condenser device 126. However, in this case the water outlet 128 and the separator effect only have to be made available for the anode recirculation gas ARG actually desired, so that, accordingly, the separator of the water outlet 128 can be designed smaller than would be the case with the variant of FIG. 2.

FIG. 4 also shows further subcomponents which can be used in a fuel cell system 100 according to the invention. Here, part of the temperature of the cathode exhaust gas KAG is used for additional heating of the anode feed gas AZG in that a cathode discharge heat exchanger 133 in heat-transferring contact with the anode supply section 122 is provided. This option is therefore intended to introduce the highest possible temperature effect into the anode feed gas AZG.

FIG. 5 also shows further subcomponents with which the fuel cell system 100 can be further developed. On the one hand, these are a cathode recirculation fan 171 and a cathode divider section 137 which allow a part of the cathode exhaust gas KAG to be diverted into a cathode recirculation section 170. This means that this diverted part of the cathode exhaust gas KAG can be fed as cathode recirculation gas KRG into an ejector device as cathode mixing section 135 and cathode recirculation can be guaranteed. Thus, a variable recirculation fraction at the cathode is possible, whereby higher recirculation rates can be set under partial load operation. The remaining cathode exhaust gas KAG is fed to the catalyst device 136 in the way already explained several times.

Also shown in FIG. 5 is a control valve 160 in the fuel gas supply for the fuel gas BRG. This is in particular designed to be quantitatively controllable, so that different volume flows of fuel gas BRG can be set and different quantities of fuel gas can also actually be added to the anode recirculation gas ARG for different operating situations.

FIG. 6 shows a further embodiment of a fuel cell system 100 according to the invention, whereby most of the elements depicted correspond to those of FIG. 5. In addition, a post-treatment unit 191 is provided here which is located downstream of the air-heat exchanger 190. The post-treatment unit 191 is particularly advantageous when operating the fuel cell system 100 with ammonia, in order to convert traces of ammonia once again before the exhaust gas is released into the environment. For this purpose, the post-treatment unit 191 can for example be designed as an ammonia slip catalyst (ASC) which functions at temperatures between 200° C. and 500° C. It can also be advantageous if a purge valve and/or bypass valve (not shown in FIG. 6) is provided to remove hydrogen and/or ammonia in the event of a leak. A corresponding valve can be provided for all embodiments.

The individual components, in particular the system consisting of a large number of heat exchangers, can be freely combined with each other and, in particular, can be freely switched via control valve systems in order to be able to react as flexibly as possible to a wide variety of operating situations of the fuel cell system 100.

Explained more explicitly, the additional components of the embodiment of the fuel cell system 100 shown in FIG. 2, i.e. the anode supply heat exchanger 121 and/or the air-heat exchanger 190, in the same positioning relative to the divider section 125, can also be combined, in addition, with the system components of the embodiments of the fuel cell system 100 from FIG. 1, 3, 4 or 5.

Furthermore, the additional component of the embodiment of the fuel cell system 100 shown in FIG. 3, i.e. the cathode supply heat exchanger 131, can also be combined, in addition, with the system components of the embodiments of the fuel cell system 100 from FIG. 1, 2, 4 or 5.

In addition, the additional component of the embodiment of the fuel cell system 100 shown in FIG. 4, i.e. the cathode discharge heat exchanger 133, can also be combined, in addition, with the system components of the embodiments of the fuel cell system 100 from FIG. 1, 2, 3 or 5.

Likewise, the additional components of the embodiment of the fuel cell system 100 shown in FIG. 5 and/or FIG. 6, i.e. the cathode recirculation section 170 with the cathode recirculation fan 171 and the cathode divider section 137 and/or the post-treatment unit 191 and/or the control valve 160 can be combined, in addition, with the system components of the embodiments of the fuel cell system 100 from FIG. 1, 2, 3 or 4.

The above explanation of the embodiments describes the present invention exclusively in the context of examples.

### LIST OF REFERENCE SIGNS

100 fuel cell system
110 fuel cell stack
120 anode section
121 anode supply heat exchanger
122 anode supply section
123 mixing section
124 anode discharge section
125 divider section
126 condenser device
128 water outlet
130 cathode section
131 cathode supply heat exchanger
132 cathode supply section
133 cathode discharge heat exchanger
134 cathode discharge section
135 cathode mixing section
136 catalyst device
137 cathode divider section
140 anode recirculation section
150 anode outlet section
160 control valve
170 cathode recirculation section
171 cathode recirculation fan
190 air-heat exchanger
191 post-treatment unit
AZG anode feed gas
AAG anode exhaust gas
AUG anode outlet gas
ARG anode recirculation gas
KZG cathode feed gas
KAG cathode exhaust gas
KRG cathode recirculation gas
BRG fuel gas
LU air
KW condensation water

1. Fuel cell system for generating electrical energy, comprising a fuel cell stack with an anode section and a cathode section, the anode section comprising an anode supply section for supplying anode feed gas (AZG) and an anode discharge section for discharging anode exhaust gas (AAG), the cathode section comprising a cathode supply section for supplying cathode feed gas (KZG) and a cathode discharge section for discharging cathode exhaust gas (KAG), wherein the anode discharge section has a divider section for dividing the anode exhaust gas (AAG) into an anode recirculation section for recirculation as anode recirculation gas (ARG) and an anode outlet section for discharge into the environment as anode outlet gas (AUG), characterised in that a condenser device is arranged in the anode discharge section or in the anode recirculation section in heat-transmitting contact with the cathode supply section to cool the anode exhaust gas (AAG) or the anode recirculation gas (ARG) by heating up the cathode feed gas (KZG), wherein a water outlet is arranged downstream of the condenser device to discharge the condensation water (KW) condensed in the condenser device, wherein a mixing section is arranged downstream of the water outlet for mixing the anode recirculation gas (ARG) with fuel gas (BRG) and for supplying this, as anode feed gas (AZG), into the anode supply section.

2. Fuel cell system according to claim 1, wherein the anode discharge section has an anode supply heat exchanger in heat-transferring contact with the anode supply section to transfer heat from the anode exhaust gas (AAG) to the anode feed gas (AZG).

3. Fuel cell system according to claim 1, wherein the mixing section is designed as an ejector device, with a fuel supply of fuel gas (BRG) at a primary connection of the ejector device and the anode recirculation section at the secondary connection of the ejector device.

4. Fuel cell system according to claim 1, wherein the cathode discharge section has a catalyst device which is connected in a fluid-communicating manner to the anode outlet section for catalytic post-treatment of the anode outlet gas (AUG) and the cathode exhaust gases (KAG).

5. Fuel cell system according to claim 1, wherein the cathode supply section has a cathode supply heat exchanger in heat-transferring contact with the cathode discharge section to transfer heat from the cathode exhaust gas (KAG) to the cathode feed gas (KZG).

6. Fuel cell system according to claim 1, wherein the divider section is located at one of the following positions:
upstream of the condenser device,
downstream of the condenser device and downstream of the water outlet,
downstream of the condenser device and upstream of the water outlet.

7. Fuel cell system according to claim 1, wherein a cathode discharge heat exchanger is arranged in the anode supply section, preferably downstream of an anode supply heat exchanger, to transfer heat from the cathode exhaust gas (KAG) to the anode feed gas (AZG).

8. Fuel cell system according to claim 1, wherein a cathode supply heat exchanger is arranged in the cathode supply section to transfer heat from the cathode exhaust gas (KAG) to the cathode feed gas (KZG).

9. Fuel cell system according to claim 1, wherein a control valve is located in the anode supply section upstream of the mixing section to control the volume flow of fuel gas (BRG) through the mixing section.

10. Fuel cell system according to claim 1, wherein the anode discharge section is designed without an external cooling circuit.

11. Fuel cell system according to claim 1, wherein a cathode mixing section, in particular in the form of an ejector device, is arranged in the cathode supply section, a cathode recirculation section being connected in a fluid-communicating manner to the secondary connection thereof to recirculate part of the cathode exhaust gas (KAG) as cathode recirculation gas (KRG).

12. Method for recirculating anode exhaust gas (AAG) in a fuel cell system having the features of claim 1 as anode recirculation gas (ARG), comprising the following steps:
diverting at least part of the anode exhaust gas (AAG) as anode recirculation gas (ARG) to the anode recirculation section,
cooling the anode recirculation gas (ARG) to below the boiling temperature of water by transferring heat to the cathode feed gas (KZG),
separating the condensed condensation water (KW) from the anode recirculation gas (ARG),
mixing the dried anode recirculation gas (ARG) with a fuel gas (BRG) to form anode feed gas (AZG).
